(19) United States
(12) Patent Application Publication
(10) Pub. No.: US 2011/0210958 A1
(43) Pub. Date: Sep. 1, 2011

(54) ORGANIC LIGHT EMITTING DISPLAY DEVICE AND DRIVING METHOD THEREOF

(75) Inventors: Myoung-Hwan Yoo, Yongin-City (KR); Choon-Yul Oh, Yongin-City (KR)

(73) Assignee: SAMSUNG MOBILE DISPLAY CO., LTD., Yongin-City (KR)

(21) Appl. No.: 12/916,465

(22) Filed: Oct. 29, 2010

(30) Foreign Application Priority Data
Feb. 26, 2010 (KR) 10-2010-0018118

(51) Int. Cl. G06F 3/038

(52) U.S. Cl. 345/214; 345/76

(57) ABSTRACT

An organic light emitting diode (OLED) display device constructed as an embodiment includes a pixel including an OLED and a driving transistor; a compensator sinking a predetermined current into a path by which a driving electric current flows in the OLED through a data line electrically connected to the pixel, determining a threshold voltage and a kickback voltage of the driving transistor by receiving a predetermined voltage applied to a gate electrode of the driving transistor on a basis of the predetermined electric current, and determining an amount of compensation based on the threshold voltage and the kickback voltage determined; a timing controller adjusting the input image data signal by the amount of compensation; and a data driver generating a data voltage based on the adjusted image data signal, and supplying the data voltage to the pixel. A driving method of the OLED display device is disclosed.

### CLAIM OF PRIORITY

This application makes reference to, incorporates the same herein, and claims all benefits accruing under 35 U.S.C. §119 from an application earlier filed in the Korean intellectual Property Office on 26 Feb. 2010 and there duly assigned Serial No. 10-2010-0018118.

### BACKGROUND OF THE INVENTION

1. Field of the Invention

The present invention relates to an organic light emitting diode (OLED) display device and a driving method manufacturing an organic light emitting diode display device. More particularly, the present invention relates to an organic light emitting diode (OLED) display device and a driving method thereof that are capable of compensating image sticking induced by deterioration of an organic light emitting diode (OLED), of displaying images having uniform luminance regardless of deviation of a threshold voltage and an electron mobility of a driving transistor, and of compensating for an error in a data signal induced by a generation of a kickback voltage of a thin film transistor.

2. Description of the Related Art

Various kinds of flat display devices that are capable of reducing detriments of cathode ray tubes (CRT), such as heavy weight and large size of CRT, have been developed in recent years. Such flat display devices include liquid crystal displays (LCDs), field emission displays (FEDs), plasma display panels (PDPs), and organic light emitting diode (OLED) display devices.

The above information disclosed in this Background section is only for enhancement of understanding of the background of the invention and therefore this section may contain information that does not form the prior art that is already known in this country to a person of ordinary skill in the art.

### SUMMARY OF THE INVENTION

It is therefore one aspect for the present invention to provide an improved OELD display device and an improved method for driving the OLED display device which may improve the quality of displayed visual images by preventing non-uniform luminance of the displayed visual images due to non-uniformity of threshold voltage of a transistor for each pixel of the organic light emitting diode (OLED) display device and deviation in the electron mobility of the transistor, and by compensating for the voltage error in the data signal induced by generation of a kickback of the driving transistor.

It is another aspect for the present invention to realize desired luminance for the displayed images by solving the problem of image sticking induced by the deterioration of the organic light emitting diode (OLED) which is included in each pixel of the organic light emitting diode (OLED) display device.

The embodiments of the present invention are not limited by the above mentioned aspects, and may include all aspects that will be readily understood by a person of ordinary skill in the art from the following description.

An organic light emitting diode (OLED) display device constructed according to the principles of an exemplary embodiment of the present invention may include a plurality of pixels each including a light emitting diode (OLED) and a driving transistor supplying a driving electric current to the organic light emitting diode (OLED); a compensator sinking a predetermined electric current into a path by which the driving electric current flows in the organic light emitting diode (OLED) through a data line electrically connected to each of the plurality of pixels, making a determination of a threshold voltage and a kickback voltage of the driving transistor by receiving a predetermined voltage applied to a gate electrode of the driving transistor included in each of the plurality of pixels in accordance with the predetermined electric current, and making a determination of an amount of compensation in accordance with an input image data signal on a basis of the threshold voltage and the kickback voltage determined; a timing controller receiving the amount of compensation, adjusting the input image data signal by the amount of compensation, and transmitting the adjusted image data signal; and a data driver generating a data voltage on a basis of the adjusted image data signal, and supplying the data voltage to the plurality of pixels.

The amount of compensation may be a voltage value representing a video signal compensating for a threshold voltage deviation attributable to the driving transistor, and may be a kickback voltage value in correspondence with the threshold voltage of the driving transistor.

The kickback voltage value may correspond to an amount of change in the threshold voltage that is shifted during a predetermined grayscale data period.

The timing controller may adjust the input image data signal by the amount of compensation in accordance with the threshold voltage of the driving transistor, may adjust the input image by the kickback voltage of the driving transistor, and may generate the adjusted image data signal. The present invention is however, not limited thereto.

The compensator may include at least one of a current sink unit sinking the predetermined current, a controller obtaining the threshold voltage and the kickback voltage and determining the amount of compensation, and a memory unit receiving and storing the predetermined voltage and storing the amount of compensation determined.

The current sink unit may include a first current sink unit sinking a predetermined first current and a second current sink unit sinking a second current having a lower current value compared to the first current. The first current may be a current value flowing in the organic light emitting diode (OLED) when the organic light emitting diode (OLED) emits light with maximum luminance.

The gate electrode of the driving transistor may be applied respectively with a first voltage and a second voltage during time periods in which the first current and the second current are sunk, and the threshold voltage and the mobility of the driving transistor may be determined on a basis of the first voltage and the second voltage.

The compensator may receive the driving voltage of the organic light emitting diode (OLED) through the data line while the organic light emitting diode (OLED) is supplied with a third current having a predetermined amplitude through the data line electrically connected to each of the plurality of pixels, and may determine the amount of compensation according to the degree of deterioration suffered by the organic light emitting diode (OLED) on a basis of the driving voltage received. The amount of compensation may be the voltage value corresponding to the driving voltage that is increased by the deterioration of the organic light emitting diode (OLED).

The compensator may further include a current source unit supplying the third current.

The organic light emitting diode (OLED) display device may further include a selection unit electrically connected to the compensator, and the data driver and a plurality of pixels, and the selection unit may include a plurality of data selection switches respectively electrically connected to the data lines, a plurality of compensator selection switches respectively electrically connected to nodes of a plurality of diverged lines diverging from the data lines, and a selection driver generating and transmitting a plurality of selection signals controlling the switching operation performed by the plurality of data selection switches and the plurality of compensator selection switches.

Each of the plurality of pixels may respectively include a first transistor electrically connected between one electrode of the organic light emitting diode (OLED) and the data line electrically connected to each of the plurality of pixels, and a second transistor electrically connected between the data line electrically connected to each of the plurality of pixels and the gate electrode of the driving transistor.

The predetermined current may be sunk, and the predetermined voltage applied to the gate electrode of the driving transistor may be transmitted to the compensator during a time period in which the first transistor and the second transistor are respectively turned on.

The predetermined current may be supplied, and the driving voltage of the organic light emitting diode (OLED) may be transmitted to the compensator during a time period in which the first transistor is turned on and the second transistor is turned off.

The data voltage corresponding to the adjusted image data signal may be supplied to the plurality of pixels during a time period in which the first transistor is turned off and the second transistor is turned on.

A driving method for an the organic light emitting diode (OLED) display device constructed as an exemplary embodiment of the principles of the present invention includes steps of sinking a predetermined electric current into a path by which a driving electric current flows in a organic light emitting diode (OLED) included in each of a plurality of pixels through a data line electrically connected to each of the plurality of pixels during a time period; making a determination of a threshold voltage and a kickback voltage by receiving a predetermined voltage applied to a gate electrode of a driving transistor included in each of the plurality of pixels in accordance with the predetermined electric current; determining an amount of compensation in accordance with an input image data signal on a basis of the threshold voltage and the kickback voltage determined; generating a data voltage by adjusting the input image data signal on a basis of the amount of compensation determined; and transmitting the data voltage to the plurality of pixels.

The amount of compensation may be a voltage value representing the video signal compensating for the threshold voltage deviation of the driving transistor, and may be a kickback voltage value corresponding to the threshold voltage of the driving transistor.

The kickback voltage value may include an amount of change of the threshold voltage that is shifted in a predetermined gray scale data period.

The step of generating the data voltage by adjusting the input image data signal may include steps of adjusting the input image data signal by the amount of compensation determined by the threshold voltage of the driving transistor included in each of the plurality of pixels, and generating the adjusted image data signal by adjusting the input image data signal by the kickback voltage of the driving transistor included in each of the plurality of pixels.

The step of making the determination of the threshold voltage and the kickback voltage in response to the predetermined voltage may include steps of sinking a first current and receiving a first voltage applied to the gate electrode of the driving transistor, and sinking a second current having a lower current value compared to the first current and receiving a second voltage applied to the gate electrode of the driving transistor.

The first current may be a current value flowing in the organic light emitting diode (OLED) when the organic light emitting diode (OLED) emits light with maximum luminance.

Before receiving the predetermined voltage, the method may further include steps of supplying a third current having a predetermined amplitude to the organic light emitting diode (OLED) included in each of the plurality of pixels through the data line electrically connected to the plurality of pixels, and receiving the driving voltage of the organic light emitting diode (OLED) and determining the amount of compensation according to the deterioration degree of the organic light emitting diode (OLED) on a basis of the transmitted driving voltage.

After receiving the predetermined voltage, the method may further include steps of supplying a third current having a predetermined amplitude to the organic light emitting diode (OLED) included in each of the plurality of pixels through the data line electrically connected to the plurality of pixels, and receiving the driving voltage of the organic light emitting diode (OLED) and determining the amount of compensation according to the degree of deterioration suffered by the organic light emitting diode (OLED) on a basis of the transmitted driving voltage.

The steps of receiving of the predetermined voltage through the data line electrically connected to each of the plurality of pixels and transmitting of the data voltage are controlled by a switching operation performed by a selection unit including a plurality of data selection switches respectively electrically connected to corresponding ones of a plurality of data lines and a plurality of compensator selection switches respectively electrically connected a plurality of diverged lines diverging from the plurality of data lines.

The selection unit may include a selection driver generating and transmitting a plurality of selection signals controlling the switching operation performed by the plurality of data selection switches and the plurality of compensator selection switches.

A first transistor of each of the plurality of pixels electrically connected between a node electrically connected to both of the driving transistor of each of the plurality of pixels and one electrode of the organic light emitting diode (OLED), and the data line electrically connected to each of the plurality of pixels, and a second transistor for each of the plurality of pixels electrically connected to the data line and the gate electrode of the driving transistor are turned on during a time period for receiving the predetermined voltage.

During a time period in which the data voltage is generated according to the adjusted image data signal and the data voltage is transmitted to the plurality of pixels, a first transistor for each of the plurality of pixels electrically connected between one electrode of the organic light emitting diode (OLED) and the data line is turned off, and a second transistor of each of the plurality of pixels electrically connected between the data line and the gate electrode of the driving transistor, is turned on.

In accordance with the embodiments of the principles of the present invention, in the organic light emitting diode (OLED) display device, the non-uniform threshold voltage and the deviation of the electron mobility of the transistor in each pixel, and non-uniform luminance due to the voltage deviation of the data signal by the generation of the kickback voltage may be prevented, thereby the quality of images displayed may be significantly improved.

Also, in accordance with the embodiments of the principles of the present invention, image sticking due to the deterioration of the organic light emitting diode (OLED) included in each pixel of the organic light emitting diode display device may be corrected so that the display devices having the desired luminance may be realized by compensating for the deterioration of the organic light emitting diode (OLED).

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an organic light emitting diode (OLED) display device constructed as exemplary embodiment of the present invention.

FIG. 2 is a circuit diagram showing a partial configuration of the OLED display device as shown in FIG. 1 constructed as an exemplary embodiment.

FIG. 3 shows a group of driving waveforms of signals supplied to a compensator, a pixel and a selection unit in accordance with an exemplary embodiment.

FIG. 4 shows a group of driving waveforms of signals supplied to a compensator, a pixel and a selection unit in accordance with an exemplary embodiment.

FIG. 5 shows a group of driving waveforms of signals supplied to a compensator, a pixel and a selection unit in accordance with an exemplary embodiment.

FIG. 6 shows a group of driving waveforms of signals supplied to a compensator, a pixel and a selection unit in accordance with an exemplary embodiment.

FIG. 7 is a circuit diagram of a pixel of an OLED display device constructed as another exemplary embodiment.

FIG. 8 is a group of driving waveforms of signals supplied to the pixel as shown in FIG. 7.

FIG. 9 is a two dimensional graph showing a trend of a kickback voltage in accordance with a change of a threshold voltage of a transistor of a pixel in an exemplary embodiment of the present invention.

FIG. 10 is a two dimensional graph showing the amplitude of an electric current as a function of gray scale of an organic light emitting diode (OLED) display device constructed as an exemplary embodiment of the present invention.

FIGS. 11A and 11B are flow charts showing methods of driving an organic light emitting diode (OLED) display device.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Constituent elements having the same structures throughout the embodiments are denoted by the same reference numerals and are described in a first embodiment. In the other embodiments, only constituent elements other than the same constituent elements will be described.

In addition, parts not related to the description are omitted for clear description of the present invention, and like reference numerals designate like elements and similar constituent elements throughout the specification.

Throughout this specification and claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Among flat panel display devices, an OLED display device using an organic light emitting diode (OLED) generating light by a recombination of electrons and holes for the display of images has faster response speed, may be driven with low power consumption, and have excellent luminous efficiency, luminance, and viewing angle. Therefore, OLED display devices are spotlighted in both industry and research fields.

Generally, the organic light emitting diode (OLED) display device may be classified into a passive matrix OLED (PMOLED) and an active matrix OLED (AMOLED) in accordance with a driving method of the organic light emitting diode (OLED).

The passive matrix uses a method in which an anode and a cathode are formed to cross each other, and cathode lines and anode lines are selectively driven; the active matrix uses a method in which a thin film transistor and a capacitor are integrated in each pixel, and a voltage is maintained by a capacitor.

Among the passive and active matrix types, the passive matrix type has a simpler structure and requires lower manufacturing cost, however, the passive matrix type may have difficulties to realize a panel of a larger size and/or higher accuracy of display of images. In contrast, the active matrix type may possibly to realize a panel of a larger size and/or higher accuracy of display of images, however, one may have technical difficulties to realize a simpler controlling method of the active matrix type and may face comparatively higher manufacturing cost during making the active matrix type.

In aspects of display resolution, display contrast, and operation speed, the current trend is toward the organic light emitting diode (OLED) display device of the active matrix type (AMOLED) display device in which respective unit pixels selectively turn on or turn off.

The luminous efficiency may be however decreased by deterioration of the organic light emitting diode (OLED) such that the light emitting luminance may be decreased based on the deteriorated current flowing in the OLED.

Also, the current flowing in the organic light emitting diode (OLED) as a representative of a same data signal may alter due to the non-uniformity of the threshold voltage of a driving transistor which controls the current flowing in the organic light emitting diode (OLED), due to a deviation of the electron mobility of the driving transistor, and due to an voltage error of the data signal induced by a kickback voltage of the driving transistor.

The deterioration of the organic light emitting diode (OLED) may result in image sticking, and the characteristic deviation of the driving transistor may result in a moire pattern.

The above information disclosed is only for enhancement of understanding of the background of the invention and therefore it may contain information that does not form the prior art that is already known in this country to a person of ordinary skill in the art.

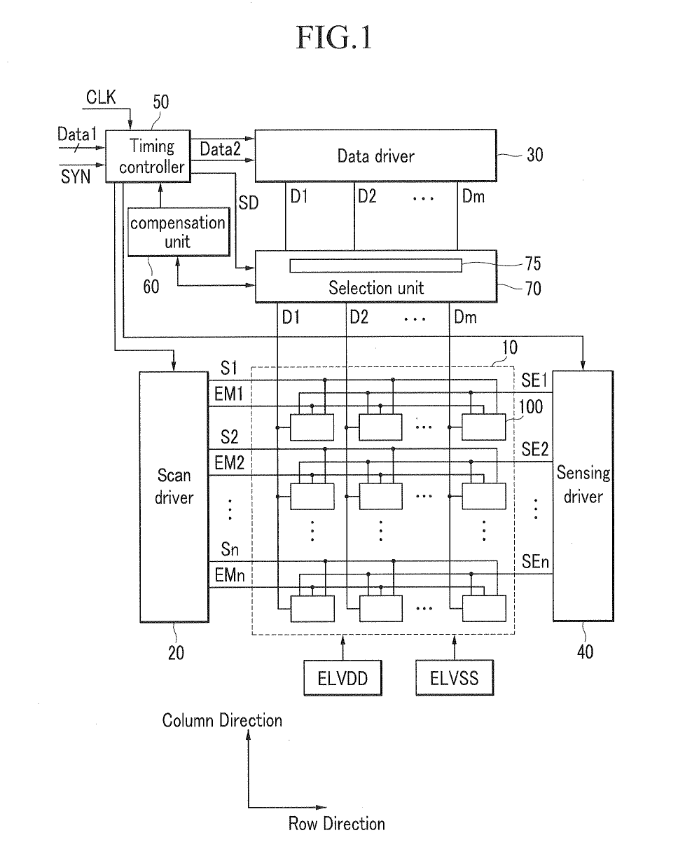

FIG. 1 is a block diagram of an organic light emitting diode (OLED) display device constructed as an exemplary embodiment of the present invention.

An organic light emitting diode (OLED) display device constructed as an exemplary embodiment of the present invention includes a display unit 10, a scan driver 20, a data driver 30, a sensing driver 40, a timing controller 50, a compensator 60, and a selection unit 70.

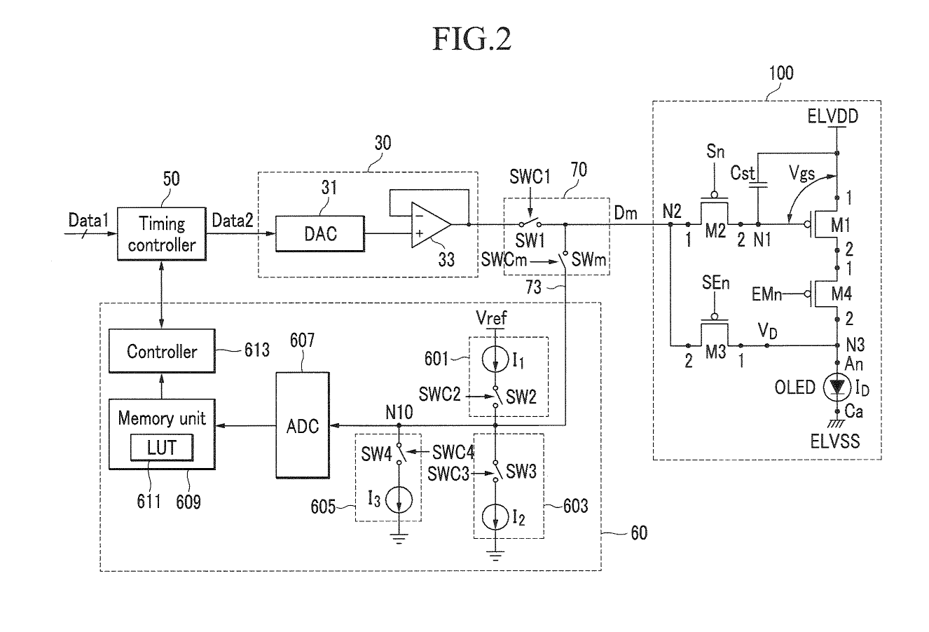

The display unit 10 includes a plurality of pixels 100 (see FIG. 2), and each pixel 100 may include an organic light emitting diode (OLED) (see FIG. 2) emitting light corresponding to a flow of a driving current as a representative of a data signal transmitted from the data driver 30.

The pixels 100 are electrically connected to a plurality of scan lines S1, S2, . . . , Sn transmitting scan signals S[i] (i=1, 2, . . . , n), a plurality of light emission control lines EM1, EM2, . . . , EMn transmitting light emission control signals EM[i] (i=1, 2, . . . , n), and a plurality of sensing lines SE1, SE2, . . . , SEn transmitting detection signals SE[i] (i=1, 2, . . . , n), and the plurality of scan lines, the plurality of light emission control lines and the plurality of sensing lines are arranged in a row direction.

Also, the pixels 100 are electrically connected to a plurality of data lines D1, D2, . . . , Dm arranged in a column direction and transmitting data signals D[j] (i=1, 2, . . . m). The plurality of data lines D1, D2, . . . , Dm may selectively further transmit a voltage applied to a gate electrode of a driving transistor capable of determining and calculating a driving voltage of the organic light emitting diode (OLED) and the threshold voltage and the mobility of the driving transistor in accordance with the degree of the deterioration of the organic light emitting diode OLED which is included in each pixel as well as the corresponding data signal.

The display unit 10 receives the first power source voltage ELVDD and the second power source voltage ELVSS from a power supply (not shown), and the first and second power source voltages ELVDD and ELVSS supply the driving current to the plurality of pixels.

The scan driver 20 may apply the scan signals S[i] to the display unit 10, and the scan driver 20 is electrically connected to the plurality of scan lines S1, S2, . . . , Sn and transmits the plurality of scan signals to the corresponding scan line among the plurality of scan lines.

Also, the scan driver 20 may apply the light emission control signals EM[i] to the display unit 10, and the scan driver 20 is electrically connected to the plurality of light emission control lines EM1, EM2, . . . , EMn and transmits the plurality of light emission control signals to the corresponding light emission control line among the plurality of light emission control lines.

In one exemplary embodiment of the present invention, the scan driver 20 generates and transmits the plurality of light emission control signals EM[i] along with the plurality of scan signals S[i], however, the present invention is not limited thereto. That is, in a display device constructed as another exemplary embodiment of the present invention, a light emission control driver (not shown) separately applying the light emission control signals may be additionally included.

The sensing driver 40 may apply the detection signals SE[i] to the display unit 10, the sensing driver 40 is electrically connected to the plurality of sensing lines SE1, SE2, . . . , SEn, and the sensing driver 40 transmits the plurality of detection signals SE[i] to the corresponding sensing line among the plurality of sensing lines.

The data driver 30 may transmit the data signals to the display unit 10, the data driver 30 may receive the image data signals Data 2 from the timing controller 50 in order to generate a plurality of data signals D[j] and may transmit the corresponding plurality of data signals to the plurality of data lines D1, D2, . . . , Dm in synchronization with the time that the plurality of scan signals are transmitted to the corresponding scan line. Thus, the plurality of data signals output from the data driver 30 are transmitted to the plurality of the pixels arranged in one row which are applied with the scan signal among the plurality of pixels 100 of the display unit 10. Thus, the driving currents representing the corresponding data signals D[j] respectively flow in the organic light emitting diodes (OLEDs) of the plurality of pixels.

The compensator 60 may detect the driving voltage of the plurality of organic light emitting diodes (OLEDs) respectively included in the plurality of pixels 100 such that the degree of deterioration (hereinafter, a deterioration degree) of the plurality of organic light emitting diodes (OLEDs) may be respectively sensed, and a data signal compensation amount for compensating for the sensed deterioration degree may be determined. Here, the data signal compensation amount is determined on a basis of the sensed deterioration degree and the data signals.

Also, the compensator 60 may sense the voltages respectively applied to the gate electrodes of the plurality of driving transistors included in the plurality of pixels, and calculate the threshold voltage and the mobility of the driving transistors to compensate for the deviation for the threshold voltage and the mobility of the plurality of driving transistors. The compensator 60 may calculate the kickback voltage generated in the gate electrodes of the plurality of driving transistors by using the calculated threshold voltage of the plurality of driving transistors.

The compensator 60 may determine the data signal compensation amount based on the calculated threshold voltage and mobility of the driving transistor regardless of the deviation of the values thereof for the organic light emitting diode (OLED) in order to emit the light with the target luminance corresponding to the data signal. The target luminance is a luminance generated when the current generated by transmitting the corresponding data signal to the driving transistor having a predetermined reference threshold voltage and a predetermined reference mobility flows in the organic light emitting diode (OLED).

The compensator 60 may store the data signal compensation amounts respectively corresponding to the plurality of image data signals for each organic light emitting diode (OLED) of the plurality of pixels. The compensator 60 may transmit the data signal compensation amount to the timing controller 50, and the timing controller 50 adds the corresponding data signal compensation amount to the image data signal corresponding to the video signal to generate the compensated image data signal. In detail, the image data signal may be a digital signal in which a digital signal of 8-bit units representing the grayscale of one pixel is continuously arranged. The timing controller 50 adds the corresponding data signal compensation amount to the digital signal of 8-bit units thereby generating the digital signal of a different bit number, for example, 10-bit units. Thus, the image data signal is the signal in which the digital signal of 10-bit units is continuously arranged.

Here, the timing controller 50 applies the kickback voltage transmitted from the compensator 60 to the compensated image data signal to again execute the image data signal amendment. The kickback voltage value is determined according to the voltage value of the threshold voltage of the driving transistor calculated in the corresponding pixel 100 such that the kickback voltage may be determined according to the correlation between the threshold voltage and the kickback voltage of the driving transistor of the pixel. The correlation of these two voltages may be represented as a lookup table or a predetermined calculation equation based on results calculated according to an experimental method. In an exemplary embodiment of the present invention, the relationship of the threshold voltage and the kickback voltage of the driving transistor may be stored in the compensator 60 as the lookup table.

The present invention is however not limited thereto. The compensator 60 may determine the data signal compensation amount to compensate for the calculated kickback voltage in the lookup table, and the compensator 60 may transmit data signal compensation amount to the timing controller 50. Here, the data signal compensation amount to compensate for the kickback voltage reflects to the data signal compensation amount to compensate for the threshold voltage and the mobility deviation of the driving transistor as described above, thereby transmitting one data signal compensation amount to the timing controller 50. Of course, two data signal compensation amounts may be separately transmitted to the timing controller 50, and the timing controller 50 may generate the image data signal by considering the two data signal compensation amounts.

Accordingly, the problem that a lookup table for each pixel for the kickback voltage is required for each grayscale data is solved, and there is a merit that the kickback voltage value corresponding to the calculated threshold voltage value of the driving transistor is applied to compensate for the image data signal.

The selection unit 70 includes a plurality of selection switches (not shown, referred to as “a data selection switch”) electrically connected to each of a plurality of data lines D1, D2, . . . , Dm, a plurality of selection switches (not shown, referred to as “a compensator selection switch”) electrically connecting to a plurality of diverged lines branched from the plurality of data lines D1, D2, . . . , Dm to the compensator 60, and a selection driver 75 generating and controlling a plurality of selection signals controlling the plurality of data selection switches and the plurality of compensator selection switches.

The plurality of data selection switches transmit the plurality of data signals D[j] output from the data driver 30 to the plurality of data lines during the period in which the display device displays the images (hereinafter, referred to as “an image display period”). That is, the plurality of data selection switches are all in the turned-on state during the image display period.

The plurality of compensator selection switches respectively connect the plurality of data lines to the compensator 60 during a period for measuring the driving voltage of the organic light emitting diode (OLED) and during a period for receiving the gate voltages of the plurality of driving transistors to calculate the characteristic deviation of the threshold voltage (hereinafter, a sum of the period for measuring the driving voltage of the organic light emitting diode (OLED) and the period for receiving the gate voltages of the plurality of driving transistors to calculate the characteristic deviation of the threshold voltage is referred to as “a sensing period”). The plurality of compensator selection switches are all in the turned-off state during the image display period. The plurality of compensator selection switches are sequentially turned on during the sensing period.

The selection driver 75 may receive the selection driving control signal SD from the timing controller 50 to generate a plurality of first selection signals controlling the switching operation performed by the plurality of data selection switches or a plurality of second selection signals controlling the switching operation performed by the plurality of compensator selection switches. The description of the selection unit 70 corresponding to the driving timing according to an exemplary embodiment of the present invention will be described with reference to FIG. 2 in detail.

The plurality of data selection switches are turned on by the plurality of first selection signals during the image display period, such that the pixels included in the predetermined pixel row among the plurality of pixels may emit light on a basis of the driving current representing the data signal transmitted from the corresponding data lines.

During the sensing period, the plurality of compensator selection switches are sequentially turned on according to the plurality of second selection signals. During the period in which the predetermined pixel row is applied by the detection signals SE[i], the plurality of diverged lines branched from the plurality of data lines connected to the compensator 60 through the compensator selection switches are sequentially turned on. Thus, the plurality of pixels of the pixel column that is applied by the detection signal are connected to the compensator 60. This operation is repeated for the plurality of sensing lines SE1, SE2, . . . , SEn, and the plurality of pixels of the corresponding pixel column. Accordingly, the information for the plurality of pixels that are applied by the detection signals SE[i] is transmitted to the compensator 60 according to the corresponding second selection signal. Here, the information for the pixel may include the driving voltage of the organic light emitting diode (OLED), and the mobility or the voltage applied to the gate electrode of the driving transistor.

The timing controller 50 is electrically connected to a selection driver 75 included in the scan driver 20, the data driver 30, the sensing driver 40, and the selection unit 70, and receives a video signal, a synchronic signal SYN, and a clock signal CLK to generate and transmit the control signal controlling the selection driver 75 included in the scan driver 20, the data driver 30, the sensing driver 40, and the selection unit 70.

The timing controller 50 receives video signals Data 1 (RGB image signals) including red, blue, and green components, and generates the image data signals Data 2 by using the data signal compensation amount transmitted from the compensator 60.

Here, the timing controller 50 reflects the threshold voltage of the driving transistor, the mobility of the driving transistor, and the data signal compensation amount to compensate for the deviation for the driving voltage of the organic light emitting diode (OLED), and reflects the data signal compensation amount to compensate for the deviation of the kickback voltage value of the driving transistor to the video signal to generate the image data signal Data 2. The image data signal Data 2 is transmitted to the data driver 30, and the data driver 30 transmits the plurality of data signals D[j] according to the image data signal Data 2 to the plurality of pixels of the display unit 10. Thus, all pixels emit the light according to the current of which the deviation by the threshold voltage of the plurality of driving transistors, the mobility of the driving transistor, the kickback voltage, and the deterioration of the organic light emitting diode (OLED) is compensated. In the present invention, the kickback voltage value may correspond to the difference between the data voltage value Vdata according to the data signal transmitted to the gate electrode of the driving transistor and the voltage value Vgate actually applied to the gate electrode of the driving transistor.

In detail, a circuit diagram of the portion and the pixel of the organic light emitting diode (OLED) display device constructed as an exemplary embodiment of the present invention will be described with reference to FIG. 2.

FIG. 2 shows the configuration portion particularly including the compensator 60 among the configuration of the organic light emitting diode (OLED) display device of FIG. 1, and a circuit diagram of the pixel 100 connected to the corresponding data line Dm among the plurality of data lines.

The pixel 100 shown in FIG. 2 is a representative pixel of a position corresponding to the n-th pixel row and the m-th pixel column among the plurality of pixels included in the display unit 10 shown in FIG. 1.

The pixel 100 according to the exemplary embodiment of FIG. 2 includes an organic light emitting diode (OLED), a driving transistor M1, a first transistor M3, a second transistor M2, a third transistor M4, and a storage capacitor Cst.

The pixel 100 includes the organic light emitting diode (OLED) emitting light according to the driving current I_{D} inflowed to the anode An, and the driving transistor M1 transmitting the driving current to the organic light emitting diode (OLED).

The driving transistor M1 is placed between the anode An of the organic light emitting diode (OLED) and the first power source voltage ELVDD thereby controlling the current amount passing by the organic light emitting diode (OLED) from the first power source voltage ELVDD and flowing into the second power source voltage ELVSS.

In detail, the gate electrode of the driving transistor MI is electrically connected to one terminal of the storage capacitor Cst, and the first electrode is connected to the other terminal of the storage capacitor Cst and to the first power source voltage ELVDD. The driving transistor M1 controls the driving current I_{D} flowing into the organic light emitting diode (OLED) from the first power source voltage ELVDD corresponding to the voltage value according to the data signal stored to the storage capacitor Cst. Here, the organic light emitting diode (OLED) emits light corresponding to the current amount supplied from the driving transistor M1.

The first transistor M3 is disposed between the anode of the organic light emitting diode (OLED) and the data line Dm connected to the pixel 100 among the plurality of data lines, and receives the driving voltage V_{D} of the organic light emitting diode (OLED) from the organic light emitting diode (OLED).

In detail, the gate electrode of the first transistor M3 is connected to the sensing line SEn connected to the pixel 100 among the plurality of sensing lines, the first electrode is connected to the anode of the organic light emitting diode (OLED), and the second electrode is connected to the corresponding data line Dm among the plurality of data lines. The first transistor M3 is turned on when the sensing line SEn is supplied with the detection signal of the gate-on voltage level, and the first transistor M3 is turned off otherwise. The detection signal may be supplied during the sensing period.

The second transistor M2 is electrically connected to the scan line Sn connected to the pixel 100 among the plurality of scan lines and the data line Dm connected to the pixel 100 among the plurality of data lines thereby transmitting the data signal to the driving transistor M1 in response to the scan signal transmitted from the scan line Sn.

In detail, the gate electrode of the second transistor M2 is electrically connected to the corresponding scan line among the plurality of scan lines Sn, the first electrode is connected to the corresponding data line Dm among the plurality of data lines, and the second electrode is connected to the gate electrode of the driving transistor M1. In this way, the second transistor M2 is turned on when the scan line Sn is supplied with the scan signal of the gate-on voltage level, and the second transistor M2 is turned off otherwise. The scan signal is the on-voltage level only during the period in which the voltage applied to the gate electrode of the driving transistor M1 is sensed, and the period in which the predetermined data signal is transmitted from the data line Dm in the compensator 60 among the sensing period.

The third transistor M4 is disposed between the anode An of the organic light emitting diode (OLED) and the driving transistor M1, the third transistor M4 is electrically connected to the light emission control line EMn connected to the pixel 100 among the plurality of light emission control lines, and the third transistor M4 controls the light emitting of the organic light emitting diode (OLED) in response to the light emission control signal transmitted from the light emission control line EMn.

In detail, the gate electrode of the third transistor M4 is electrically connected to the corresponding light emission control line EMn among the plurality of light emission control lines, the first electrode is connected to the second electrode of the driving transistor M1, and the second electrode is connected to the anode An of the organic light emitting diode (OLED). The third transistor M4 is turned on if the light emission control signal having the gate-on voltage level is supplied to the light emission control line EMn, and the third transistor M4 is turned off otherwise.

One terminal of the storage capacitor Cst is electrically connected to the gate electrode of the driving transistor M1, and the other terminal thereof is electrically connected to the first electrode of the driving transistor M1 and the first power source voltage ELVDD.

If the data signal is transmitted from the data line Dm, the voltage applied to the first node N1 connected to one terminal of the storage capacitor Cst and the gate electrode of the driving transistor is changed corresponding to the data signal. Next, if the current path is formed between the first power source ELVDD and the cathode Ca of the organic light emitting diode (OLED) by the turn-on of the driving transistor M1 and the third transistor M4, the current corresponding to the voltage value Vgs of the driving transistor M1 (Vgs refers to the voltage difference between the voltage of the data signal applied to the gate electrode of the driving transistor M1 and the voltage ELVDD applied to the first electrode of the driving transistor M1) is applied to the organic light emitting diode (OLED), thereby emitting light with brightness corresponding thereto.

On the other hand, the compensator 60 shown in FIG. 2 is connected to the timing controller 50 and the selection unit 70, and the selection unit 70 connects the data driver to the pixel 100 along with the compensator 60.

The compensator 60 may include the current source unit 601, the first current sink unit 603, the second current sink unit 605, and an analog-digital converter (hereafter referred to as “ADC”) 607.

The pixel 100 in FIG. 2 is only one representative pixel among the entire plurality of pixels of the display unit 10, and the compensation process and the driving of the compensator 60, the timing controller 50, the selection unit 70, and the data driver included in the organic light emitting diode (OLED) display device according to an exemplary embodiment of the present invention are executed for the entire pixels of the display unit 10.

In FIG. 2, the data selection switch SW1 and the compensator selection switch SWm that are electrically connected to the data line Dm connected to the pixel 100 are shown as examples of the plurality of data selection switches and the plurality of compensator selection switches of the selection unit 70.

The compensator selection switch SWm is electrically connected to the diverged line branched from the data line Dm connected to the pixel 100. Here, the diverged line from the data line means the compensation line 73.

If the compensator selection switch SWm is switched on during the sensing period, the sensing of the pixel 100 is executed through the compensator selection switch SWm after the compensation line 73 and the data line Dm are electrically connected. The compensation line 73 connected to the corresponding data line Dm is connected to a current source unit 601, a first current sink unit 603, and a second current sink unit 605 of the compensator 60. The current sink unit and the current source unit both provide electric current while the electric current provided by the current source unit flows away from the current source unit and the electric current provided by the current sink unit flows toward the current sink. When the compensator 60 sinks an electric current in a current path, compensator 60 provides an electric current in a current direction toward the compensator 60.

The current source unit 601 includes the first switch SW2, and is controlled by the switching operation performed by the first switch SW2. The first current sink unit 603 includes the second switch SW3, and the first current sink unit 603 is controlled by the second switch SW3. The second current sink unit 605 includes the third switch SW4, and the second current sink unit 605 is controlled by the third switch SW4. The selection signals controlling the switching operation performed by the first switch SW2, the second switch SW3, and the third switch SW4 may be generated in and transmitted from the timing controller 50, or may be generated in and transmitted from the selection driver 75 of the selection unit 70.

The first switch SW2, the second switch SW3, and the third switch SW4 may be commonly connected to one node N10, and the voltage of the node N10 is transmitted to the ADC 607.

In FIG. 2, one current source unit 601, one first current sink unit 603, and one second current sink unit 605 are shown. The present invention is however not limited thereto. More than one current source unit 601, first current sink unit 603, and second current sink unit 605 may be provided in the compensator 60.

Likewise, in FIG. 2, one ADC 607 connected to the current source unit 601, the first current sink unit 603, and the second current sink unit 605 is shown, however a plurality of ADCs 607 that are respectively connected to a plurality of current source units 601, a plurality of the first current sink units 603, and a plurality of the second current sink units 605, or are connected into a group, may be provided.

If one compensator selection switch SWm is switched on during the sensing period among the plurality of compensator selection switches, the first switch SW2 included in the current source unit 601 may be switched on such that the current source unit 601 supplies the first current I₁ to the compensation line 73 and the data line Dm corresponding to the turned-on compensator selection switch SWm. Thus, the first current I₁ is supplied to the pixel of which the first transistor M3 is turned on among the plurality of pixels connected to the corresponding data lines Dm.

Hereafter, for better understanding and ease of description, it is determined that the turned-on compensator selection switch is SWm, and the pixel to which the first current is supplied is pixel 100.

The first current I₁ flows into the organic light emitting diode (OLED) through the turned-on first transistor M3. Here, the driving transistor M1, the second transistor M2, and the third transistor M4 are in the turned-off state. Thus, the driving voltage (hereinafter, “the first voltage”) of the organic light emitting diode (OLED) corresponding to the first current is generated in the third node N3, and the first voltage is supplied to the ADC 607. The first voltage supplied to the ADC 607 is the voltage of which the deterioration degree of the organic light emitting diode (OLED) is reflected.

When the organic light emitting diode (OLED) included in the pixel 100 is deteriorated, the resistance of the organic light emitting diode (OLED) may be increased, and the driving voltage of the organic light emitting diode (OLED) is increased according to the resistance increased. When supplying the first current I₁ to the OLED, if the driving voltage (hereinafter, “a reference driving voltage”) of the organic light emitting diode (OLED) before the deterioration and the driving voltage of the current organic light emitting diode (OLED) when the first current I₁ is supplied are compared, the deterioration degree of the organic light emitting diode (OLED) may be confirmed. That is, the voltage transmitted to the ADC 607 is converted into the digital value, and the compensator 60 compares the digital value corresponding to the reference driving voltage to the converted digital value thereby determining the deterioration degree. The driving voltage detection of the organic light emitting diode (OLED) of the pixel 100 executed in the current source unit 601 is executed in response to each turn-on of the plurality of compensator selection switches during the period in which the plurality of detection signals SE[i] are respectively transmitted to the corresponding sensing lines.

In this embodiment, the first voltages of all pixels 100 of the display unit 10 are transmitted to the ADC 607 during the sensing period.

If one compensator selection switch SWm among the plurality of compensator selection switches is turned on during the sensing period, the second switch SW3 included in the first current sink unit 603 is turned on such that the first current sink unit 603 sinks the second current I₂ to the corresponding pixel 100 among the plurality of pixels through the compensation line 73 and the data line Dm corresponding to the turned-on compensator selection switch SWm. The second current I₂ passes through the driving transistor M1 from the first power source voltage ELVDD through the turned-on first transistor M3, and is sunk. Thus, the voltage (hereinafter, “the second voltage”) applied to the gate electrode of the driving transistor M1 is supplied to the ADC 607. The second voltage supplied to the ADC 607 is used when calculating the threshold voltage and the mobility of the driving transistor M1.

The second current value may be variously determined for the predetermined voltage to be applied with a determined time, particularly as the current value corresponding to the higher grayscale data voltage. Preferably, when the pixel 100 emits light with maximum luminance, it may be determined as the current value Imax to be inflowed into the organic light emitting diode (OLED).

The second voltage detection of the driving transistor M1 of the pixel 100 executed in the first current sink unit 603 is executed in response to the turn-on of each compensator selection switch during the period in which the plurality of detection signals are respectively transmitted to the corresponding sensing lines. In this embodiment, the second voltages of all pixels of the display unit 10 are detected during the sensing period to transmit them to the ADC 607.

On the other hand, one compensator selection switch is turned on during the sensing period among the plurality of compensator selection switches and the third switch SW4 included in the second current sink unit 605 is turned on, and the second current sink unit 605 sinks the third current I₃ from the data line Dm corresponding to the turned-on compensator selection switch. The third current I₃ passes through the driving transistor M1 from the first power source voltage ELVDD through the turned-on first transistor M3, and is sunk. Thus, the voltage (hereinafter, “the third voltage”) that is applied to the gate electrode of the driving transistor M1 is supplied to the ADC 607. Likewise, the third voltage supplied to the ADC 607 is used to calculate the threshold voltage and the mobility of the driving transistor M1 of the pixel 100.

Here, the third current I₃ may have a current value that is less than the second current I₂. A current value corresponding to the lower grayscale data voltage may be determined.

In the exemplary embodiment, the third current I₃ may be determined as a current value of 0.1% to 50% of the second current I₂. Particularly, the current value corresponding to the minimum grayscale data voltage may be determined.

In the exemplary embodiment, the third voltage of the pixel 100 sensed when sinking to the third current may be firstly compensated by using the difference between the third voltage value and the voltage value of the gate electrode of the driving transistor of the pixel detected when sinking to the current value corresponding to the grayscale data voltage, and the third voltage of the pixel 100 may be used to calculate the threshold voltage and the mobility of the driving transistor. This may cover drawbacks generated when sinking to the lower current as the current value corresponding to the minimum grayscale data voltage while maintaining the merit.

That is, the third current I₃ has a higher current value compared to the current value corresponding to the minimum grayscale data voltage, and senses the third voltage within a shorter time period such that the real time compensation may become easier. The difficulty of obtaining black luminance may be compensated by calculating and reflecting the compensation voltage value representing the difference between the third voltage and the voltage of the driving transistor sensed when sinking to the current value corresponding to the minimum grayscale data voltage.

The detection of the third voltage of the driving transistor of the pixel 100 executed in the second current sink unit 605 proceeds in all pixels of the display unit 10 in response to the turn-on of the plurality of compensator selection switches SWm, and the third voltages of all pixels may be detected and transmitted to the ADC 607 during the sensing period.

The second voltages and the third voltages respectively sensed for the plurality of pixels during the sensing period may be used for obtaining the threshold voltage and the electron mobility of the driving transistor respectively included in the plurality of pixels.

In the exemplary embodiment of FIG. 2, the compensator 60 may include two current sink units 603 and 605 and one current source unit 601, however the present invention is not limited thereto, and the sensing may be executed by setting up different sink current values in one current sink unit.

The ADC 607 converts the first voltage, the second voltage, and the third voltage that are respectively sensed for all of the pixels included in the display unit 10 and respectively supplied from the current source unit 601, the first current sink unit 603, and the second current sink unit 605 into digital values.

Also, referring to FIG. 2, the compensator 60 may further include a memory unit 609 and a controller 613.

The memory unit 609 stores the digital values representing the first voltage, the second voltage, and the third voltages transmitted from the ADC 607.

The controller 613 calculates the threshold voltage and the mobility deviation of the plurality of driving transistors and the deterioration degree of the plurality of organic light emitting diodes (OLED) by using the digital information for the first voltage, the second voltage, and the third voltage sensed for the plurality of pixels.

For example, the current value of the second current I₂ may be set as a current value Imax when the pixel emits light with the maximum luminance, and the current value of the third current is set as the current value corresponding to the lower grayscale data voltage, particularly as the current value 1/256Imax corresponding to 1/256 of the Imax.

When sinking the second current and the third current, the voltage value of the gate electrode of the driving transistor M1 of FIG. 2, that is, the voltage value V1 of the second voltage, and the voltage value V2 of the third voltage may be calculated as following Equations 1 and 2.

$$\begin{matrix}[ Equation 1 ] & \\ V 1 = ELVDD - \sqrt{\frac{2 I max}{β}} - \vert Vth M 1 \vert & ( 1 ) \\ [ Equation 2 ] & \\ V 2 = ELV DD - \frac{1}{16} \sqrt{\frac{2 I max }{β}} - \vert Vth M 1 \vert & ( 2 )\end{matrix}$$

(2) ELVDD of Equations 1 and 2 as the voltage value supplied from the first power source voltage ELVDD is the voltage applied to the first electrode of the driving transistor M1.

Also, β is the mobility of the electrons moving in the channel of the driving transistor M1, and |VthM1| is an original threshold voltage of the driving transistor M1 of the pixel 100.

Accordingly, the controller 613 may obtain the threshold voltage Q2 and the mobility Q1 of the driving transistor M1 as two unknown quantities by using the following Equations 3 and 4.

$$\begin{matrix}[ Equation 3 ] & \\ Q 1 = \sqrt{\frac{2 I max}{β}} = \frac{16}{15} ( V 2 - V 1 ) & ( 3 ) \\ [ Equation 4 ] & \\ Q 2 = \vert V th M 1 \vert = ELVDD - Q 1 - V 1 & ( 4 )\end{matrix}$$

The calculated threshold voltage and mobility of the driving transistor for the plurality of pixels may be stored in the memory unit 609.

Also, the memory unit 609 may store the deterioration degree of the plurality of organic light emitting diodes (OLED).

As described above, the memory unit 609 may store the deviation of the threshold voltage and the mobility of the driving transistor of each pixel, and the deterioration degree of the organic light emitting diode (OLED) as the pixel unit.

The controller 613 may calculate the data signal compensation amount compensating for the image data signals according to the calculated threshold voltage and the mobility of the driving transistor M1, and the deterioration degree of the organic light emitting diode (OLED). The memory unit 609 may store the data signal compensation amount as a lookup table 611. Here, the lookup table 611 stores the data signal compensation amount for compensating for the image data signals, the calculated threshold voltage and the mobility of the driving transistor, and the deterioration degree deviation of the organic light emitting diode (OLED), or a calculation equation to calculate the data signal compensation amount.

On the other hand, the controller 613 may determine the kickback voltage value on a basis of the calculated threshold voltage of the driving transistor M1 for the plurality of pixels. Also, when the threshold voltage is increased due to the driving of the driving transistor M1, the change amount Vshift of the kickback voltage value corresponding to the shifted threshold voltage may be calculated. In an exemplary embodiment of the present invention, the relationship of the threshold voltage and the kickback voltage of the driving transistor may be stored in the compensator 60 as the lookup table type. The controller 613 may determine the data signal compensation amount to compensate the kickback voltage calculated in the lookup table.

The timing controller 50 may transmit the image data signal Data1 of a predetermined bit representing the grayscale of an arbitrary pixel in the video signal to the controller 613. The controller 613 may detect the information of the threshold voltage of the driving transistor, the mobility deviation, the kickback voltage deviation determined on a basis of the threshold voltage, and the deterioration degree of the organic light emitting diode (OLED) from the memory unit 609, and extracts the data signal compensation amount from the lookup table 611 to compensate for the image data signal transmitted according to the detected deviation and deterioration degree.

The controller 613 transmits the extracted data signal compensation amount to the timing controller 50. The timing controller 50 may generate the amended image data signal Data2 by adding the data signal compensation amount to the image data signal Data1 and may transmit the amended image data signal Data2 to the data driver 30.

In detail, the image data signal Data1 may be the digital signal in which the digital signals of 8-bit units representing the grayscale of one pixel are continuously arranged. The timing controller 50 may add the data signal compensation amount corresponding to the digital signal of the 8-bit units to generate the digital signal of different bits, for example a digital signal of 10-bit units. Thus, the amended image data signal Data2 may become signal in which the digital signal of 10-bit units is continuously arranged.

The data driver 30 generates the data signal D[j] by using the amended image data signal Data2 supplied to the data driver 30, and supplies the generated data signal D[j] to the plurality of pixels 100 of the display unit 10. Therefore, in the plurality of pixels, the image sticking may be compensated, and simultaneously the reason for generating the moire pattern may be removed. In addition, the deviation of the kickback voltage according to the threshold voltage of the driving transistor may be compensated such that an image having uniform luminance may be displayed by the OLED.

The compensating process of the image data signal that is compensated in the timing controller 50 is not limited by the sequence, and may be compensated by the data signal compensation amount according to the sequence extracted from the memory unit 609.

Particularly, the kickback voltage value of the threshold voltage that is shifted according to the change of the threshold voltage of the driving transistor M1 may be determined for the compensation to remove the error generated in the image data signal.

Here, the kickback voltage value is finally applied for the image data signal Data1 input from the external such that the voltage Vdata according to the compensated image data signal may be determined by the following Equation 5.

$$\begin{matrix}[ Equation 5 ] & \\ Vdata = ELVDD - \sqrt{( \frac{100}{100 - 30 \frac{α}{127}} ) {( \frac{data}{{2}^{m} - 1} )}^{γ} ( \frac{2 I max}{β } )} - \vert Vth M 1 \vert - Vkickback & ( 5 )\end{matrix}$$

In Equation 5, 100/(100−30α/127) is a variable applied under the compensation of the image data signal of each pixel, and m is the bit number. In Equation 5, γ is gamma correction, for example, gamma 2.2.1 curve. In Equation 5, α denotes a degree of image sticking, and α may be defined as one of the values divided into 127 when the degree of image sticking is compensated up to 30%. For example, when α is 127, 100−(30*127)/127=70; therefore, the degree of image sticking is 30%.

Also, the kickback voltage value calculated on a basis of the threshold voltage of the driving transistor is applied such that the amended image data signal Data2 is determined and transmitted, thereby light may be emitted with the luminance of the desired level, and the error generated in the image data signal may be reduced.

The amended image data signal Data2 passes through the digital-analog converter 31 of the data driver 30 and is converted into an analog data signal.

The analog data signal may be supplied to the data line Dm connected to the corresponding pixel 100 among the plurality of pixels through an operational amplifier 33 of a negative feedback type. Thus, the organic light emitting diode (OLED) of the pixel 100 emits the light according to the amended data signal such that the image sticking and the moire pattern may be removed in the image of the entire display unit 10, and a quality image reflecting the kickback element may be provided.

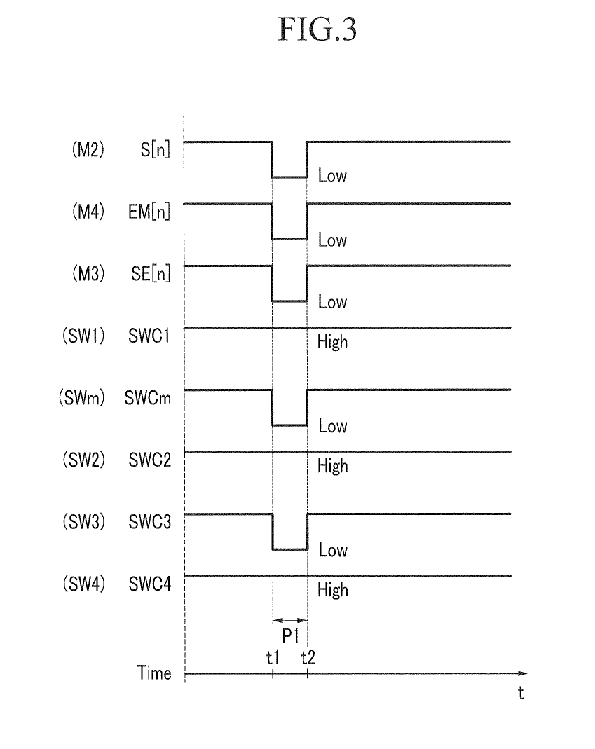

A process of detecting the driving voltage of the organic light emitting diode (OLED) or the gate electrode voltage of the driving transistor and emitting the light for compensation of the image data signal according to the waveforms of FIG. 3 to FIG. 6 will be described with reference to the circuit diagram of FIG. 2.

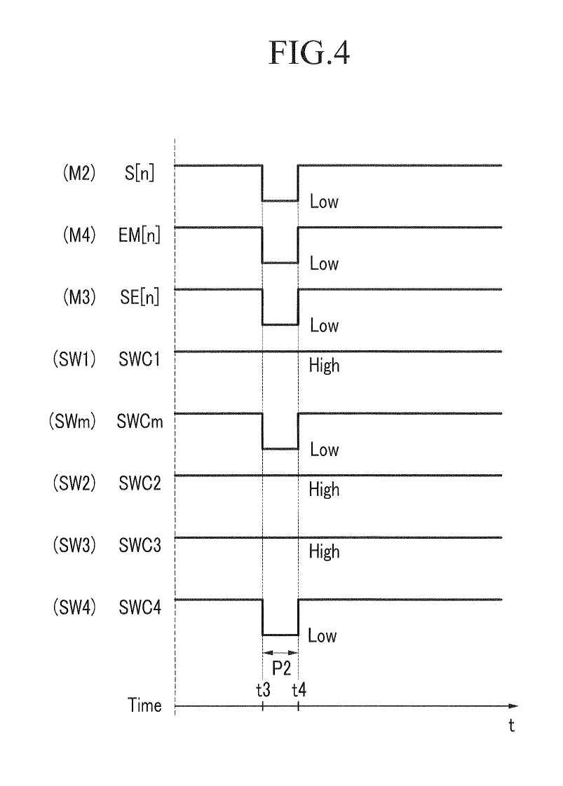

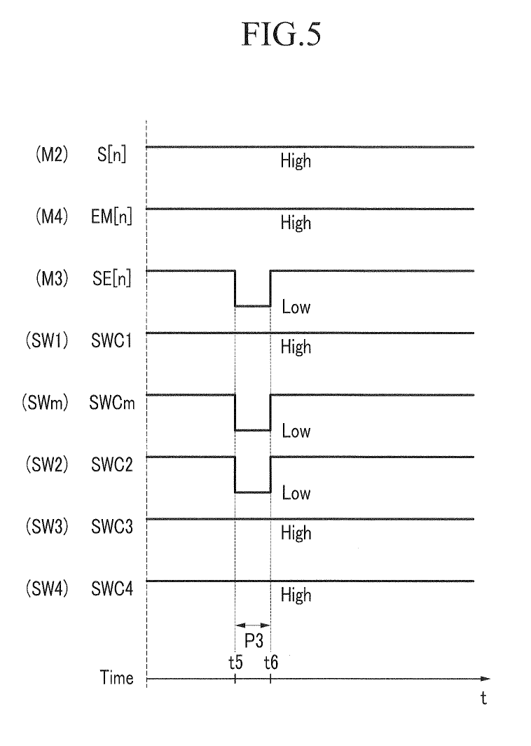

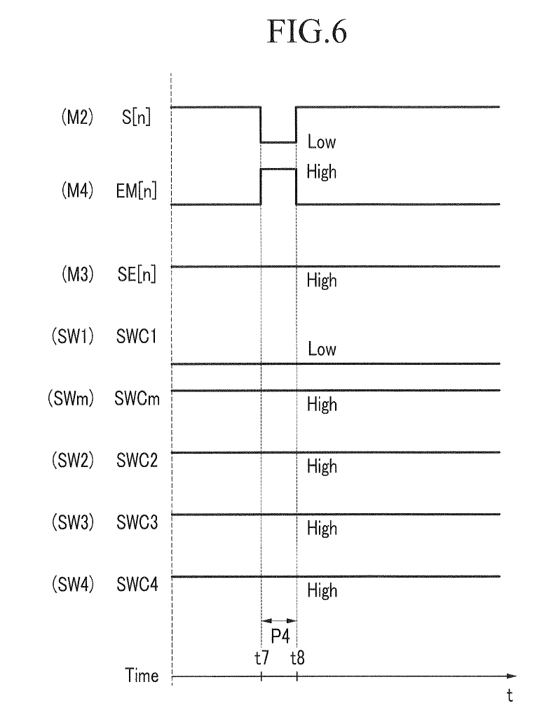

FIG. 3 is a waveform diagram for the first current sink unit 603 to sense the second voltage, and FIG. 4 is a waveform diagram for the second current sink unit 605 to sense the third voltage. FIG. 5 is a waveform diagram for the current source unit 601 to sense the first voltage, and FIG. 6 is a waveform diagram to display the image in the pixel 100 transmitted the data signal.

The waveforms of FIG. 3 through FIG. 6 are provided by using the transistors and the plurality of PMOS selection switches consisting of the circuit of the pixel 100 provided in FIG. 2, and if the transistors and the plurality of selection switches included in the circuit of the pixel 100 are realized as NMOS, the polarities thereof will be inverted.

The sensing process of the voltage applied to the gate electrode of the driving transistor M1 of the pixel 100 according to the waveform of FIG. 3 is as follows.

The data selection signal SWC1 controlling the data selection switch SW1 connected to the data line corresponding to the pixel 100 at the time t1 is transmitted to the high level such that the data selection switch SW1 is turned-off. In contrast, the compensator selection signal SWCm is transmitted to the low level at the time t1 such that the compensator selection switch SWm connected to the compensation line 73 divided from the data line corresponding to the pixel 100 is turned-on.

A scan signal S[n], a light emission control signal EM[n], and a detection signal SE[n] that are supplied to the pixel 100 are transmitted as a low level voltage at a time t1. Accordingly, in the pixel 100, the second transistor M2 transmitted the scan signal S[n], the third transistor M4 transmitted the light emission control signal EM[n], and the first transistor M3 transmitted the detection signal SE[n] are turned on at the time t1.

During the time period P1 in which the second transistor M2, the third transistor M4, and the first transistor M3 are turned on, the second switch SW3 of the first current sink unit 603 is turned on by the selection signal SWC3 of the low level. Thus, the second current I₂ is sunk through the connected data line through the turned-on compensator selection switch during this period P1.

Accordingly, the driving transistor M1 is turned on such that the current path is formed from the first power source voltage ELVDD to the cathode of the organic light emitting diode (OLED). Also, the voltage difference Vgs between the gate electrode of the driving transistor M1 and the first electrode is formed as the voltage value corresponding to the second current I₂ such that the voltage (the second voltage) of the gate electrode of the driving transistor M1 is applied to the first node N1.

The second voltage is transmitted to the ADC 607 passing through the data line Dm connected to the pixel 100 through the second transistor M2, and the compensation line 73, and the second voltage is converted into the digital value.

Referring to FIG. 4, the data selection signal SWC1 controlling the data selection switch SW1 is transmitted to the high level from the time t3 to the time t4 such that the data selection switch SW1 is turned off. In contrast, the compensator selection signal SWCm is transmitted to the low level at the time t3 such that the compensator selection switch SWm connected to the compensation line 73 divided from the data line corresponding to the pixel 100 is turned on.

At the time t3, the scan signal S[n], the light emission control signal EM[n], and the detection signal SE[n] supplied to the pixel 100 are transmitted to the low level voltage such that the second transistor M2, the third transistor M4, and the first transistor M3 are turned on during the period P2.

Here, the third switch SW4 of the second current sink unit 605 is turned on in response to the selection signal SWC4 of the low level. Thus, the second current sink unit 605 sinks the third current I₃ through the data line connected through the turned-on compensator selection switch SWm during the period P2.

Accordingly, the driving transistor M1 is turned on such that the current path is formed from the first power source voltage ELVDD to the cathode of the organic light emitting diode (OLED). Also, the voltage difference Vgs between the gate electrode of the driving transistor M1 and the first electrode is formed as the voltage value corresponding to the third current I₃ such that the voltage (the third voltage) of the gate electrode of the driving transistor M1 is applied to the first node N1.

The third voltage is transmitted to the ADC 607 through the data line Dm connected to the pixel 100, the second transistor M2, and the compensation line 73, and the third voltage is converted into the digital value.

The memory unit 609 of the compensator 60 stores the digital value of the converted second voltage and the third voltage, and the controller 613 calculates the threshold voltage and the electron mobility of the driving transistor M1 of the pixel 100 from the values of second and third voltage.

The waveform diagram of FIG. 5 is the waveform diagram of the period in which the driving voltage of the organic light emitting diode (OLED) of the pixel 100 is sensed.

The data selection signal SWC1 is transmitted to the high level during the time period P3 from the time t5 to the time t6 such that the data selection switch SW1 is turned off, and the compensator selection signal SWCm is the low level such that the compensator selection switch SWm connected to the compensation line 73 divided from the data line corresponding to the pixel 100 is turned on.

The data selection signals and the compensator selection signals may be provided by the compensator 60, or selection unit 70, or a separate data selection driver (not shown), or any combination thereof.

During the period P3, the scan signal S[n] and the light emission control signal EM[n] are transmitted to the high level voltage, and the detection signal SE[n] is transmitted to the low level voltage.

Accordingly, the second transistor M2 transmitted the scan signal S[n] and the third transistor M4 transmitted the light emission control signal EM[n] in the pixel 100 are turned off during the period P3, and the first transistor M3 transmitted the detection signal SE[n] is turned on during the period P3.

Here, the first switch SW2 of the current source unit 601 receives the selection signal SWC2 of the low level, and is turned on in response to the selection signal SWC2. Thus, the current source unit 601 supplies the first current I₁ to the organic light emitting diode (OLED) through the compensation line 73 and the data line Dm connected through the turned-on compensator selection switch SWm during period P3.

In the normal organic light emitting diode (OLED), the driving voltage applied to the anode An is the appropriate voltage value corresponding to the first current I₁, however, in the deteriorated organic light emitting diode (OLED), the resistance is increased such that the driving voltage applied to the anode of the organic light emitting diode (OLED) is relatively increased. The above increased driving voltage of the organic light emitting diode (OLED) is the first voltage, and the first voltage is transmitted to the ADC 607 after the data line Dm and the compensation line 73 through the turned-on first transistor M3, and is converted into the digital value.

The memory unit 609 stores the digital value of the converted first voltage, and the controller 613 determines the data signal compensation amount compensating by the voltage value increased by the deterioration based on the first voltage for the organic light emitting diode (OLED) to emit the light with the appropriate luminance according to the data signal.

FIG. 6 is a waveform diagram for emitting the light according to the normal data signal through the pixel 100.

The data selection signal SWC1 is the low level during the period from the time t7 to the time t8 such that the data selection switch SW1 connected to the data line corresponding to the pixel 100 is turned on in response thereto. In contrast, the compensator selection signal SWCm is transmitted to the high level during the period of the time t7 to time t8 such that the compensator selection switch SWm connected to the compensation line 73 divided from the data line corresponding to the pixel 100 is turned off.

The scan signal S[n] supplied to the pixel 100 at the time t7 is changed to the low level voltage, and the second transistor M2 is turned on during the period P4.

The data driver 30 transmits the compensated data signal to the corresponding data line Dm through the turned-on data selection switch SW1 during the period P4. The data signal is passed through the second transistor M2 and is transmitted to the first node N1, and the storage capacitor Cst connected to the first node N1 charges the voltage value corresponding to the data signal.

The data signal transmitted to the pixel 100 is generated from the amended image data signal Data2 in the timing controller 50. The data voltage according to the finally amended image data signal is reflected by the kickback voltage value corresponding to the extracted threshold voltage of the driving transistor M1 in the previously discussed process.

The timing controller 50 receives the compensation amount deterioration according to the organic light emitting diode (OLED) of the pixel 100 or compensation amount compensating the threshold voltage and the mobility deviation of the driving transistor M1 from the compensator 60, reflects the compensation amount compensating the deviation of the kickback voltage corresponding to the threshold voltage, and includes the bit number of the image data signal Data1 supplied from the exterior to generate the amended image data signal Data2.

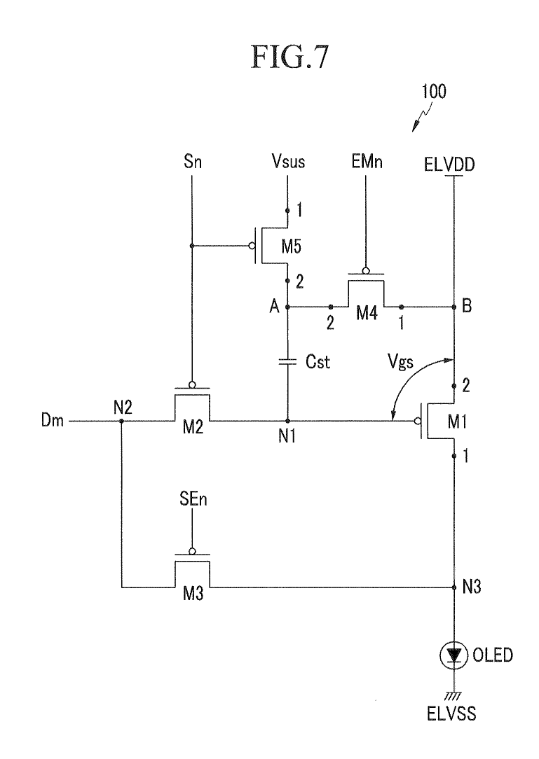

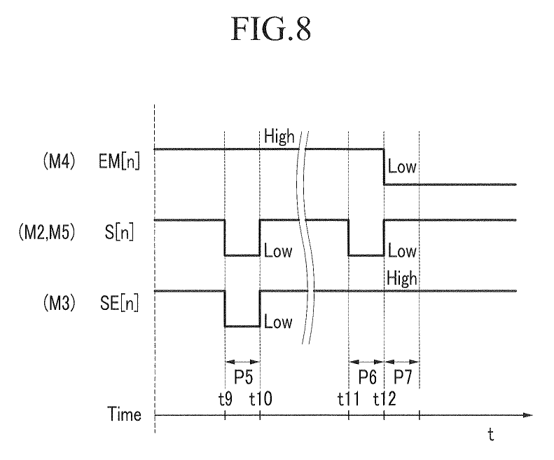

FIG. 7 is a circuit diagram of the pixel 100 shown in FIG. 1 according to another an exemplary embodiment, and FIG. 8 shows a driving waveform of signals supplied to the pixel.

The configuration of the pixel of FIG. 7 is similar to the configuration of the pixel of FIG. 2 such that it will be described focusing on the differences.

Referring to FIG. 7, the pixel 100 includes an organic light emitting diode (OLED), a driving transistor M1, a first transistor M3, a second transistor M2, a third transistor M4, a fourth transistor M5, and a storage capacitor Cst.

Compared with the pixel of FIG. 2, the third transistor M4 receiving the corresponding light emission control signal through the n-th light emission control line EMn is connected between the node A and the node B to which the second electrode of the driving transistor M1 and the first power source voltage ELVDD are connected.

In detail, the gate electrode of the third transistor M4 is connected to the corresponding light emission control line EMn among the plurality of light emission control lines, the first electrode is connected to the second electrode of the driving transistor M1, and the second electrode is connected to the node A. The third transistor M4 is turned on if the light emission control line EMn is supplied with the light emission control signal having the gate-on voltage level, and the third transistor M4 is turned off otherwise. The light emission control signal is transmitted to the gate-on voltage level after the period in which the predetermined data signal is transmitted from the data line Dm, that is, the period the data is written. Thus, the driving current according to the data voltage charged to the storage capacitor Cst through the driving transistor M1 is supplied to the organic light emitting diode (OLED), thereby displaying the images.

The storage capacitor Cst has one terminal connected to the gate electrode of the driving transistor M1 and the other terminal connected to the first electrode of the driving transistor M1 and the first power source voltage ELVDD.

The storage capacitor Cst is charged with the voltage corresponding to the threshold voltage of the driving transistor M1. If the data signal is transmitted from the data line Dm, the voltage applied to the first node N1 connected to one terminal of the storage capacitor Cst and to the gate electrode of the driving transistor M1 is changed corresponding to the data signal. Here, the storage capacitor Cst stores the voltage corresponding to the data signal transmitted from the data line Dm.

The other terminal of the storage capacitor Cst is electrically connected to the node A, and the fourth transistor M5 is electrically connected between the node A and the assistance power source Vsus.

In detail, the gate electrode of the fourth transistor M5 is electrically connected to the corresponding scan line Sn among the plurality of scan lines, the first electrode is connected to the assistance power source VSUS, and the second electrode is connected to the node A.

The fourth transistor M5 is turned on in response to the scan signal of the gate-on voltage level transmitted through the scan line Sn, and the fourth transistor M5 is turned off otherwise. The scan signal of the on voltage level is supplied during the period in which the voltage applied to the gate electrode of the driving transistor M1 in the compensator 60 and the driving voltage of the organic light emitting diode (OLED) are sensed and the period in which the predetermined data signal is transmitted from he data line Dm.

Thus, the fourth transistor M5 is turned on corresponding to the scan signal such that the node A is transmitted the assistance voltage of the assistance poser source Vsus. The assistance voltage Vsus may compensate for the voltage value that is dropped according to the IR drop phenomenon of the first power source voltage ELVDD.

A process in which the driving voltage of the organic light emitting diode (OLED) or the gate electrode voltage of the driving transistor M1 are detected for the compensation of the image data signal according to the waveform diagram of FIG. 8 and the pixel 100 emits the light will be described with reference to the circuit diagram of the pixel 100 of FIG. 7.

As shown in FIG. 8, the scan signal S[n] and the detection signal SE[n] supplied to the pixel 100 are transmitted to the low level voltage at the time t9. Accordingly, the second transistor M2 and the fourth transistor M5 receiving the scan signal S[n] and the first transistor M3 receiving the detection signal SE[n] in the pixel 100 are turned on during the period P5 from the time t9 to the time t10.

Thus, the predetermined current is sunk from the compensator 60 such that the voltage difference Vgs between the gate electrode of the driving transistor M1 and the first electrode is formed as the voltage value corresponding to the predetermined current such that the voltage of the gate electrode of the driving transistor M1 is applied to the first node N1. The voltage is passed by the data line Dm connected to the pixel 100, and is transmitted to the compensator 60. Accordingly, the threshold voltage and the mobility of the driving transistor M1 are calculated and the compensation amount is determined as described above.

Even though not shown in FIG. 8, the waveform during the period in which the driving voltage of the organic light emitting diode (OLED) of the pixel 100 for the compensation of the image sticking is the same as described above such that the detailed description is omitted.

After the sensing process of the voltage for the compensation, the scan signal S[n] among the control signals supplied to the pixel 100 at the time t11 is only applied in the low level such that the second transistor M2 and the fourth transistor M5 are turned on during the period P6.

The driving transistor M1 is also turned on during the period P6, and the predetermined compensated data signal is transmitted from the corresponding data line Dm. The storage capacitor Cst is charged by the data voltage according to the data signal, and the assistance voltage is applied to the other terminal of the storage capacitor Cst through the fourth transistor M5 to maintain the supplying voltage of the stable first power source voltage ELVDD.

Next, the corresponding scan signal S[n] is increased to the high level at the time t12, and the corresponding light emission control signal EM[n] is transmitted to the low level voltage.

Accordingly, the second transistor M2 and the fourth transistor M5 are turned off and the third transistor M4 is turned on during the period P7 such that the driving current corresponding to the voltage according to the data signal stored in the storage capacitor Cst is transmitted to the organic light emitting diode (OLED), and therefore the organic light emitting diode (OLED) emits the light.

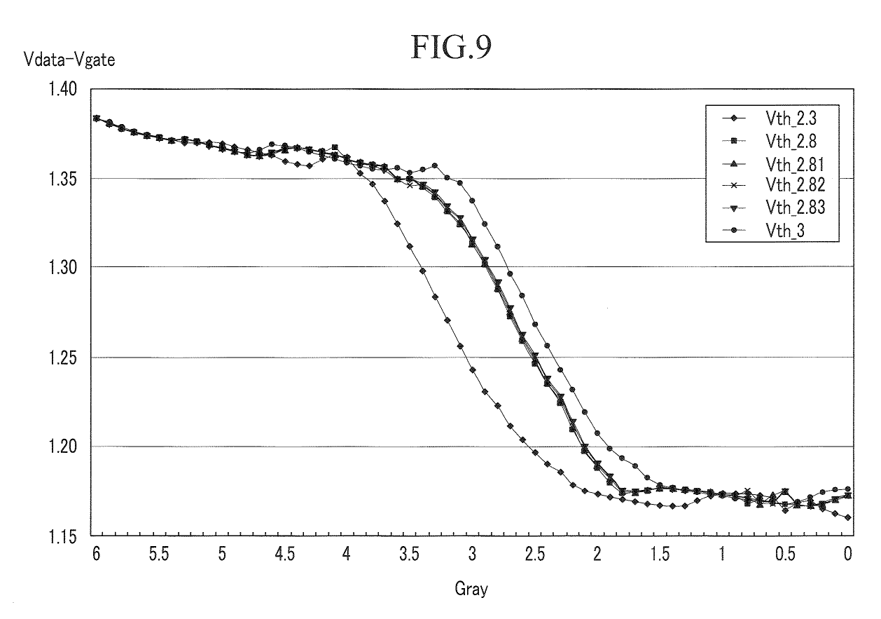

FIG. 9 is a two dimensional graph showing a trend of a kickback voltage according to a change of a threshold voltage Vth of a transistor of a pixel in accordance with an exemplary embodiment of the present invention.

The graph of FIG. 9 supplements the kickback fact for the compensated image data signal by the compensation amount to realize the uniform luminance regardless of the compensation amount of the image sticking and the threshold voltage and the mobility deviation of the driving transistor, thereby being used for compensating the error occurring to the light emitting according to the data signal.

In detail, a relationship of the kickback voltage value of the Y-axis as a function of the grayscale of the X-axis is represented.

The kickback voltage value corresponds to the difference between the data voltage value Vdata according to the data signal transmitted to the gate electrode of the driving transistor M1 and the voltage value Vgate transmitted through the gate electrode of the driving transistor M1.

As shown in the graph of FIG. 9, if the threshold voltage of the driving transistor is extracted, the kickback voltage value may be obtained.

Therefore, if the threshold voltage is changed and increased, the kickback voltage value for the same grayscale data is increased corresponding to the threshold voltage.

Also, if the threshold voltage is changed and increased in the predetermined grayscale data, the predetermined kickback voltage value corresponding to that period may be determined. Thus, the predetermined kickback voltage value may be reflected after the compensation for the input image data signal such that the error for the data voltage for the compensated image data signal may be reduced.

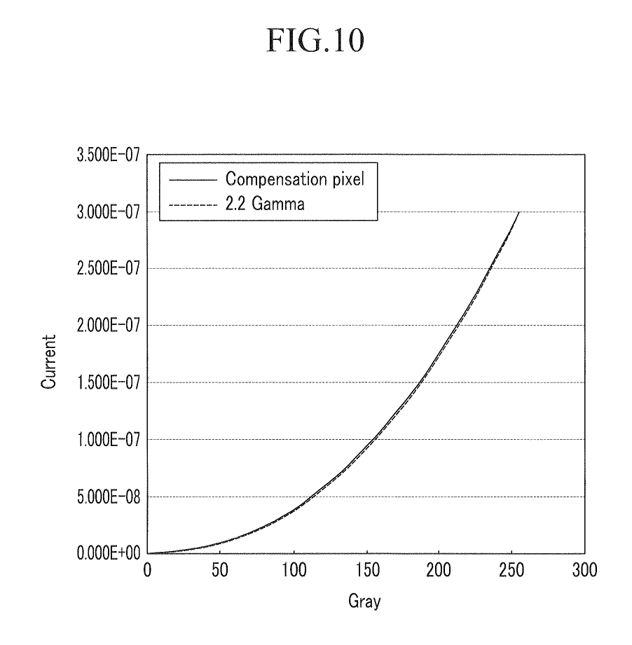

FIG. 10 is a graph showing a current curved line per grayscale of an organic light emitting diode (OLED) display device constructed as an exemplary embodiment of the present invention.

The graph of FIG. 10 shows a result of removing the error for the data voltage after the image sticking compensation and the compensation for the uniform luminance are executed in the organic light emitting diode (OLED) display device and the kickback voltage value is reflected.

Referring to FIG. 10, the current curved line per grayscale of the pixel image emitting the light according to the data signal resulted from the amended image data signal achieved by the method according to an exemplary embodiment of the present invention accords with the 2.2 gamma curve such that it may be confirmed that the low grayscale data region may be sufficiently expressed.

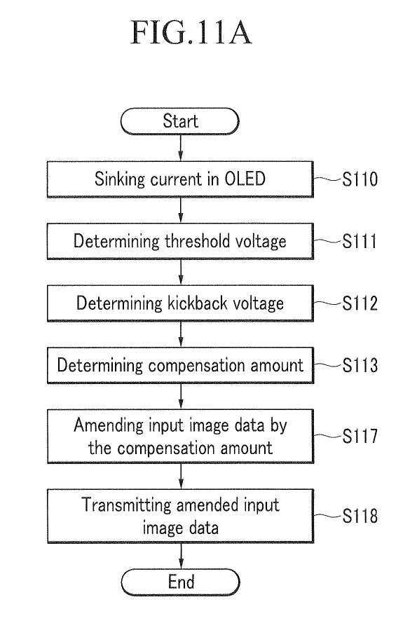

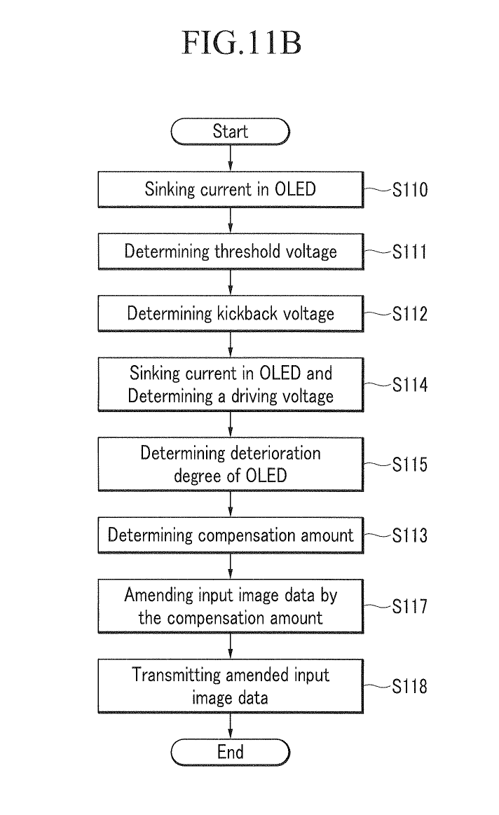

FIGS. 11A and 11B are flow charts showing methods of driving an organic light emitting diode display (OLED) device.

In one embodiment as shown in FIG. 11A, a method for driving an organic light emitting diode (OLED) display device includes sinking a predetermined electric current into a path by which a driving electric current flows in a organic light emitting diode (OLED) included in each of a plurality of pixels through a data line electrically connected to each of the plurality of pixels during a time period (S110); determining a threshold voltage by receiving a predetermined voltage applied to a gate electrode of a driving transistor included in each of the plurality of pixels on a basis of the predetermined electric current (S111); determining a kickback voltage of the driving transistor included in each of the plurality of pixels (S112); determining a compensation amount in accordance with an input image data signal on a basis of the threshold voltage and the kickback voltage determined (S113); generating a data voltage by amending the input image data signal on a basis of the compensation amount determined (S117); and transmitting the data voltage to the plurality of pixels (S118).

In another embodiment as shown in FIG. 11B, a method for driving an organic light emitting diode (OLED) display device includes sinking a predetermined electric current into a path by which a driving electric current flows in a organic light emitting diode (OLED) included in each of a plurality of pixels through a data line electrically connected to each of the plurality of pixels during a time period (S110); determining a threshold voltage by receiving a predetermined voltage applied to a gate electrode of a driving transistor included in each of the plurality of pixels on a basis of the predetermined electric current (S111); determining a kickback voltage of the driving transistor included in each of the plurality of pixels (S112); supplying another current to the organic light emitting diode (OLED) included in each of the plurality of pixels through a data line electrically connected to each of the plurality of pixels, and receiving a driving voltage of the organic light emitting diode (OLED) (S114); determining a deterioration degree of organic light emitting diode (OLED) determined by the driving voltage received (S115); determining a compensation amount in accordance with an input image data signal on a basis of the threshold voltage, the kickback voltage and the deterioration degree of OLED (S113); generating a data voltage by amending the input image data signal on a basis of the compensation amount determined (S117); and transmitting the data voltage to the plurality of pixels (S118). In another embodiment, steps S114 and S115 may be performed prior to Step S110.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10: display unit 20: scan driver

30: data driver

31: digital-analog converter

33: calculation amplifier

40: sensing driver 50: timing controller

60: compensator 70: selection unit

73: compensation line 75: selection driver

100: pixel 601: current source unit

603: first current sink unit 605: second current sink unit

607: ADC 609: memory unit

611: lookup table 613: controller

What is claimed is:

1. An organic light emitting diode (OLED) display device, comprising:
a plurality of pixels each including a light emitting diode (OLED) and a driving transistor supplying a driving electric current to the organic light emitting diode (OLED);
a compensator sinking a predetermined electric current into a path by which the driving electric current flows in the organic light emitting diode (OLED) through a data line electrically connected to each of the plurality of pixels, making a determination of a threshold voltage and a kickback voltage of the driving transistor by receiving a predetermined voltage applied to a gate electrode of the driving transistor included in each of the plurality of pixels in accordance with the predetermined electric current, and making a determination of an amount of compensation in accordance with an input image data signal in dependence upon the threshold voltage and the kickback voltage determined;
a timing controller responding to the amount of compensation by adjusting the input image data signal received, and transmitting the adjusted image data signal; and
a data driver generating a data voltage on a basis of the adjusted image data signal, and supplying the data voltage to the plurality of pixels.

2. The organic light emitting diode (OLED) display device of claim 1, wherein the compensator determines the amount of compensation having a voltage value representing a video signal for compensating a threshold voltage deviation in the driving transistor, and determines the amount of compensation having a kickback voltage value in correspondence with the threshold voltage of the driving transistor.

3. The organic light emitting diode (OLED) display device of claim 2, wherein the compensator varies the kickback voltage value in correspondence with an amount of change in the threshold voltage that is shifted in a predetermined gray scale data period.

4. The organic light emitting diode (OLED) display device of claim 1,
the timing controller generating the adjusted image data signal by adjusting the input image data signal by the amount of compensation according to the threshold voltage of the driving transistor of each of the plurality of pixels, and then adjusting the input image data signal by the kickback voltage of the driving transistor of each of the plurality of pixels.

5. The organic light emitting diode (OLED) display device of claim 1 wherein the compensator comprises:
at least one of
a current sink unit sinking the predetermined current,
a controller determining the threshold voltage and the kickback voltage of the driving transistor, and determining the amount of compensation, and
a memory unit receiving and storing the predetermined voltage and storing the amount of compensation determined.

6. The organic light emitting diode (OLED) display device of claim 5, wherein the current sink unit comprises:
a first current sink unit sinking a first current having a predetermined amplitude and a second current sink unit sinking a second current having a lower current value compared to the first current.

7. The organic light emitting diode (OLED) display device of claim 6, wherein the first current is an electric current flowing in the organic light emitting diode (OLED) when the organic light emitting diode (OLED) emits light with a maximum luminance.

8. The organic light emitting diode (OLED) display device of claim 6, wherein
the gate electrode of the driving transistor included in each of the plurality of pixels is applied respectively with a first voltage and a second voltage during time periods in which the first current and the second current are sunk, and
the threshold voltage and the mobility of the driving transistor are determined on a basis of the first voltage and the second voltage.

9. The organic light emitting diode (OLED) display device of claim 1, wherein the compensator receives a driving voltage of the organic light emitting diode (OLED) through the data line while the organic light emitting diode (OLED) is supplied with a third current having a predetermined amplitude through the data line, and the compensator determines the amount of compensation according to a deterioration degree of the organic light emitting diode (OLED) according to the driving voltage received.

10. The organic light emitting diode (OLED) display device of claim 9, wherein the amount of compensation is a voltage value corresponding to the driving voltage that is increased by the deterioration of the organic light emitting diode (OLED).

11. The organic light emitting diode (OLED) display device of claim 9, the compensator further comprising a current source unit supplying the third current.

12. The organic light emitting diode (OLED) display device of claim 1, wherein the organic light emitting diode (OLED) display further comprises a selection unit electrically connected to the compensator, and the data driver and the plurality of pixels; and
the selection unit comprises
a plurality of data selection switches respectively electrically connected to data lines which are respectively electrically connected to the plurality of pixels,
a plurality of compensator selection switches respectively electrically connected to nodes of a plurality of diverged lines diverged from the data lines, and
a selection driver generating and transmitting a plurality of selection signals respectively controlling the switching operations of the plurality of data selection switches and the plurality of compensator selection switches.

13. The organic light emitting diode (OLED) display device of claim 1, wherein each of the plurality of pixels comprises:
a first transistor disposed between one electrode of the organic light emitting diode (OLED) and the data line electrically connected to each of the plurality of pixels, and
a second transistor disposed between the data line electrically connected to each of the plurality of pixels and the gate electrode of the driving transistor.

14. The organic light emitting diode (OLED) display device of claim 13, wherein the predetermined current is sunk, and the predetermined voltage applied to the gate electrode of the driving transistor is transmitted to the compensator during a time period in which the first transistor and the second transistor are turned on.

15. The organic light emitting diode (OLED) display device of claim 13, wherein the predetermined current is supplied, and the driving voltage of the organic light emitting diode (OLED) is transmitted to the compensator during a time period in which the first transistor is turned on and the second transistor is turned off.

16. The organic light emitting diode (OLED) display device of claim 13, wherein a data voltage based on the adjusted image data signal is supplied to each of the plurality of pixels during a time period in which the first transistor is turned off and the second transistor is turned on.

17. A method or driving an organic light emitting diode (OLED) display device, comprising:
sinking a predetermined electric current into a path by which a driving electric current flows in a organic light emitting diode (OLED) included in each of a plurality of pixels through a data line electrically connected to each of the plurality of pixels;
making a determination of a threshold voltage and a kickback voltage of the driving transistor by receiving a predetermined voltage applied to a gate electrode of a driving transistor included in each of the plurality of pixels in accordance with the predetermined electric current;
making a determination of an amount of compensation in accordance with an input image data signal on a basis of the threshold voltage and the kickback voltage determined;
generating a data voltage by adjusting the input image data signal on a basis of the amount of compensation determined; and
transmitting the data voltage to the plurality of pixels.

18. The method of claim 17, wherein the amount of compensation is a voltage value representing a video signal compensating a threshold voltage deviation of the driving transistor included in each of the plurality of pixels, and is the kickback voltage value determined on the basis of the threshold voltage of the driving transistor.

19. The method of claim 18, wherein the kickback voltage value comprises an amount of change of the threshold voltage that is shifted in a predetermined gray scale data period.

20. The method of claim 17, wherein the step of generating the data voltage by adjusting the input image data signal comprises steps of:
adjusting the input image data signal by the amount of compensation determined by the threshold voltage of the driving transistor included in each of the plurality of pixels, and
generating the adjusted image data signal by adjusting the input image data signal by the kickback voltage of the driving transistor included in each of the plurality of pixels.

21. The method of claim 17, wherein the step of making the determination of the threshold voltage and the kickback voltage by receiving the predetermined voltage comprises steps of:
sinking a first current and receiving a first voltage applied to the gate electrode of the driving transistor, and
sinking a second current having a lower current value compared to the first current and receiving a second voltage applied to the gate electrode of the driving transistor.

22. The method of claim 21, wherein the first current has a current value flowing in the organic light emitting diode (OLED) when the organic light emitting diode (OLED) emits light with maximum luminance.

23. The method of claim 17, further comprising,
before receiving the predetermined voltage,
supplying a third current having a predetermined amplitude to the organic light emitting diode (OLED) included in each of the plurality of pixels through a data line electrically connected to each of the plurality of pixels, and receiving a driving voltage of the organic light emitting diode (OLED), and
determining the amount of compensation on a basis of a deterioration degree of organic light emitting diode (OLED) determined by the driving voltage received.

24. The method of claim 17, further comprising,
after receiving the predetermined voltage,
supplying a third current having a predetermined amplitude to the organic light emitting diode (OLED) included in each of the plurality of pixels through a data line electrically connected to each of the plurality of pixels, and receiving a driving voltage of the organic light emitting diode (OLED), and
determining the amount of compensation on a basis of a deterioration degree of organic light emitting diode (OLED) determined by the driving voltage received.

25. The method of claim 17, wherein
the steps of receiving of the predetermined voltage through the data line electrically connected to each of the plurality of pixels and transmitting of the data voltage are
controlled by a switching operation performed by a selection unit including a plurality of data selection switches respectively electrically connected to corresponding ones of a plurality of data lines and a plurality of compensator selection switches respectively electrically connected a plurality of diverged lines to the plurality of data lines.

26. The method of claim 25, wherein the selection unit includes a selection driver generating and transmitting a plurality of selection signals controlling the switching operation performed by the plurality of data selection switches and the plurality of compensator selection switches.

27. The method of claim 17, wherein a first transistor of each of the plurality of pixels electrically connected between a node electrically connected to both of the driving transistor of each of the plurality of pixels and one electrode of the organic light emitting diode (OLED), and the data line electrically connected to each of the plurality of pixels, and a second transistor of each of the plurality of pixels electrically connected to the data line and the gate electrode of the driving transistor are turned on during a time period for receiving the predetermined voltage.

28. The method of claim 17, wherein a first transistor of each of the plurality of pixels electrically connected between one electrode of the organic light emitting diode (OLED) and the data line is turned off, and a second transistor of each of the plurality of pixels electrically connected between the data line and the gate electrode of the driving transistor, is turned on during a time period in which the data voltage is generated according to the adjusted image data signal and the data voltage is transmitted to the plurality of pixels.
